(19) United States
(12) Patent Application Publication
(10) Pub. No.: US 2008/0194126 A1
(43) Pub. Date: Aug. 14, 2008

(54) SYSTEM FOR FASTENING COMPONENTS

(75) Inventors: Mark Andrew Grant, Plymouth, MI (US); Richard Harry Knox, Fenton, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 11/673,623

(22) Filed: Feb. 12, 2007

(51) Int. Cl. H01R 11/11; H01R 4/28

(52) U.S. Cl. 439/108; 439/550; 439/883

(57) ABSTRACT

A system for fastening components including a first member having a surface that defines an extruded opening and a first engagement element. The system also includes a second member disposed in proximity to the surface, the second member having an eyelet and a second engagement element. The second member is oriented such that the eyelet is axially aligned with the extruded opening and the first and second engagement elements cooperate to inhibit the second member from rotating with respect to the first member. The system also includes a threaded fastener securing the second member to the first member through engagement of the eyelet and the extruded opening.

### BACKGROUND

1. Technical Field

A system for fastening components together.

2. Background Art

Space on automotive vehicles for mounting components is in short supply. Manufacturers densely pack the engine compartment with engine components and electrical modules of every kind. On occasion, electrical components will not fit in the engine compartment because of size constraints and space availability. Accordingly, manufacturers are frequently forced to look elsewhere on a vehicle for available space to mount electrical components. Many such electrical components must be electrically grounded in order to operate.

Most electrical components that are attached to a vehicle in the engine compartment are grounded to the negative post of the vehicle's battery or some other grounding plane within the engine compartment. A component attached on a vehicle at a location remote from the engine bay can be connected by a grounding wire to the grounding plane in the vehicle's engine compartment, but doing so may require the use of a lengthy grounding wire. Lengthy grounding wires are disfavored because of their tendency to act as an antenna and their consequential tendency to receive ambient electromagnetic radiation. Accordingly, it is desirable to use as short a grounding wire as possible when grounding electrical components on a vehicle. However, the point of attachment and its immediate vicinity may be insufficiently thick to effectively and reliably fasten a grounding terminal to that surface. This and other problems are addressed herein.

### SUMMARY

In a first embodiment, a system for fastening components is provided that includes a first member having a surface that defines an extruded opening and a first engagement element. A second member is disposed in close proximity to the surface, the second member having an eyelet and a second engagement element. The second member may be oriented such that the eyelet is axially aligned with the extruded opening and the first and second engagement elements are aligned to cooperate to inhibit the second member from rotating with respect to the first member. A threaded fastener may secure the second member to the first member through engagement of the eyelet and the extruded opening.

In at least a second embodiment, a system for securing a grounding wire to a ground plane is provided. In at least this embodiment, the system comprises an electrically grounded member having a surface that defines an extruded opening and a first engagement element. The system further comprises an electrical terminal having a wire receiving portion, an eyelet, and a second engagement element, the electrical terminal being disposed in close proximity to the surface such that the eyelet is axially aligned with the extruded opening and the first and second engagement means engage each other and cooperate to inhibit the electrical terminal from rotating with respect to the electrically grounded member. Additionally, a threaded fastener fastens the electrical terminal to the electrically grounded member through engagement of the eyelet and the extruded hole.

In a least a third embodiment, a system for fastening a grounding wire to a ground plane on a vehicle is provided. In at least this embodiment, the system comprises an automotive vehicle having an electrically grounded portion made from a material that comprises metal. The electrically grounded portion includes a surface, an extruded hole defined in the surface, and an anti-rotation slot defined in the surface in close proximity to the extruded hole. This third embodiment also includes an electrical terminal connected to the surface proximate to the extruded hole and the anti-rotation slot. The electrical terminal may be made from a material comprising metal and has an eyelet, an anti-rotation tab, and a wire receiving portion. The eyelet may be disposed in close proximity to the extruded hole and axially aligned therewith and the anti-rotation tab may be received within the anti-rotation slot. The third embodiment also includes a grounding wire having a first end and a second end. The first end may be received within the wire receiving portion of the electrical terminal and secured thereto. The second end may be attachable to an electrical component on the vehicle. The third embodiment further includes an electrically conductive screw that connects the eyelet to the extruded hole.

### BRIEF DESCRIPTION OF THE DRAWINGS

FIG. 1 is a side, cut-away view illustrating a vehicle having a body on frame construction;

FIG. 2 is a bottom elevational view of the vehicle of FIG. 1;

FIG. 3 is a perspective, fragmentary view of the portion of the vehicle identified by dotted lines in FIG. 2;

FIG. 4A is a perspective view of at least one embodiment of a wire terminal;

FIG. 4B is a perspective view of at least another embodiment of a wire terminal;

FIG. 5A is a perspective view of one embodiment of the section of the vehicle depicted in FIG. 1B;

FIG. 5B is at least another embodiment of the second of the vehicle identified with dotted lines in FIG. 1B;

FIG. 6 is an exploded perspective view of at least one embodiment of the present system;

FIG. 7 is a cutaway side elevational view of at least one embodiment of the present invention.

### DETAILED DESCRIPTION OF THE EMBODIMENT(S)

Reference will now be made in detail to the illustrated embodiments of the present invention which constitute the best modes of practicing the invention presently known to the inventors. The following descriptions are merely exemplary in nature and in no way intended to limit the invention, its application, or uses. The figures are not necessarily drawn to scale. Specific details disclosed herein are not to be interpreted as limiting, but merely as a representative basis for any aspect of the invention and/or as a representative basis for teaching one skilled in the art to variously employ the present invention.

The embodiments described herein include extruding a hole through a section of sheet metal and attaching a ground terminal to the excluded hole through the use of a threaded fastener. To ensure proper placement and alignment of the grounding wire, and a desirable tightness of the connection between the sheet metal and the wire terminal, an anti-rotation slot can be provided in the sheet metal and a protruding tab can be provided on the ground terminal. The protruding tab may be received within the anti-rotation slot and cooperate with the anti-rotation slot to prevent rotation of the ground terminal as the threaded fastener is tightened. Alternatively, the anti-rotation slot may be provided on the terminal and the protruding tab may be provided on the sheet metal.

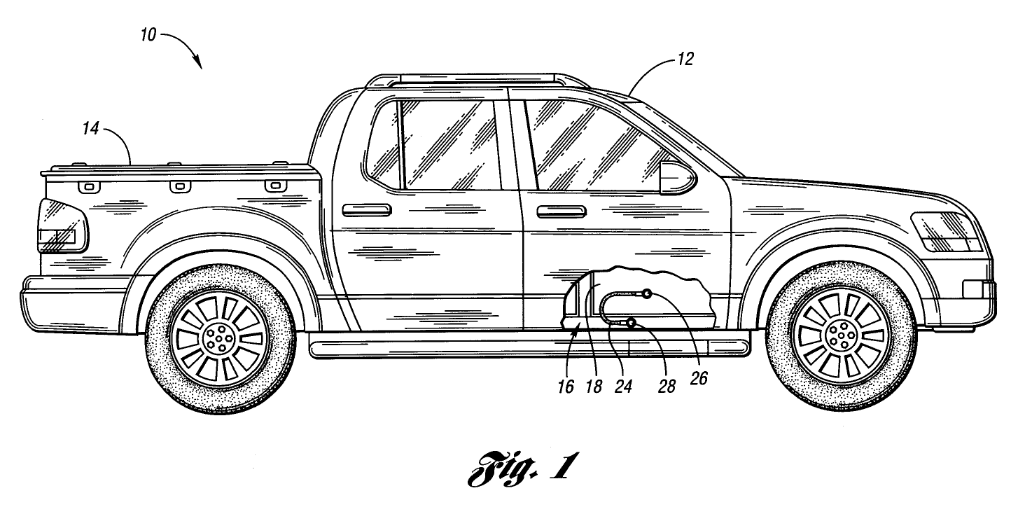

With reference to FIG. 1, a vehicle 10 is illustrated. Vehicle 10 is illustrated as being a pick-up truck. In other embodiments, vehicle 10 may be any type of automotive vehicle including passenger cars, sport utility vehicles, minivans, busses and cross over vehicles. Additionally, vehicle 10 may be other types of vehicles including airplanes, trains, boats and space craft.

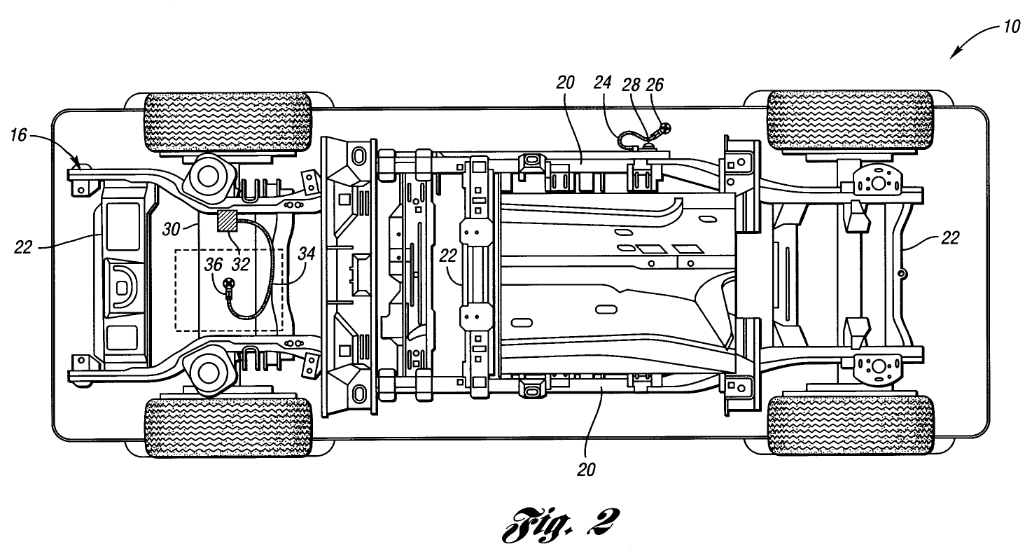

Vehicle 10 has a passenger compartment 12 and an open bed 14. Vehicle 10 has a support frame 16 to carry and support the major components of the vehicle, such as body 18, which is attached to the frame 16. Body on frame construction is commonly used on some vehicles. As shown in FIG. 2, frame 16 includes two outboard support beams 20 extending substantially the entire length of the vehicle and a plurality of cross members 22 extending between and connecting the outboard support beams 20. Frame 16 is also known as a ladder frame.

As shown in FIGS. 1 and 2, the frame 16 is electrically grounded to the body 18 by the body/frame grounding strap 24 which is connected to the body 18 at body connection 26 and connected to the frame 16 at frame connection 28.

With respect to FIG. 2, an underside of vehicle 10 is illustrated. A spare tire mounting member 30 is connected to the two outboard support beams 20 and may be used to mount a spare tire (not shown). In a preferred embodiment, spare tire mounting member 30 is welded to the outboard support beams 20 to provide both an electrical connection and a robust structural attachment. In other embodiments, spare tire mounting member 30 may be connected to the outboard support beams 20 through the use of rivets, threaded fasteners such as nuts and bolts, screws, or any other connector effective for securing spare tire mounting member 30 to the outboard support beams 20.

An electrical component 32 is illustrated mounted to the underside of the spare tire mounting member 30. Electrical component 32 may alternatively be mounted on a top side of spare tire mounting member 30. In other embodiments, electrical component 32 may be mounted elsewhere on vehicle 10. Electrical component 32 may be any electrical component that requires electrical grounding for normal operations. In at least one embodiment, electrical component 32 may be smart fuel pump driving module.

Electrical component grounding strap 34 is connected, at one end to the electrical component 32, and is connected at an opposite end to a ground terminal 36. Electrical component grounding strap 34 may be connected to ground terminal 36 through crimping, a compression fixture, a threaded connection, or by any other means effective that securely fastens electrical component grounding strap 34 to the ground terminal 36 and that creates an electrical connection between them. Ground terminal 36 is mounted on, and grounded to, the spare tire mounting member 30. Through the connection between ground terminal 36 and spare tire mounting member 30, an electrical connection is made between the electrical component 32 at one end and the body 18 (which is electrically grounded) at the other end.

FIG. 3 is an enlarged, fragmentary view of the spare tire mounting member 30, the electrical component grounding strap 34 and the ground terminal 36. As illustrated, the electrical component grounding strap 34 includes an insulating sheath 38 and a wire 40. Wire 40 is electrically connected to ground terminal 36 through the contact formed between the wire 40 and the clasp 42 that is integral with ground terminal 36. A screw 44 fastens ground terminal 36 to spare tire mounting member 30. In this view, the illustrated section of spare tire mounting member 30 is a section of sheet metal. In some embodiments, it is desirable to have at least three millimeters of threaded engagement between screw 44 and the sheet metal to which it is attached. The section of the spare tire mounting member 30 illustrated in FIG. 3 represents a section of sheet metal having a thickness of less than three millimeters.

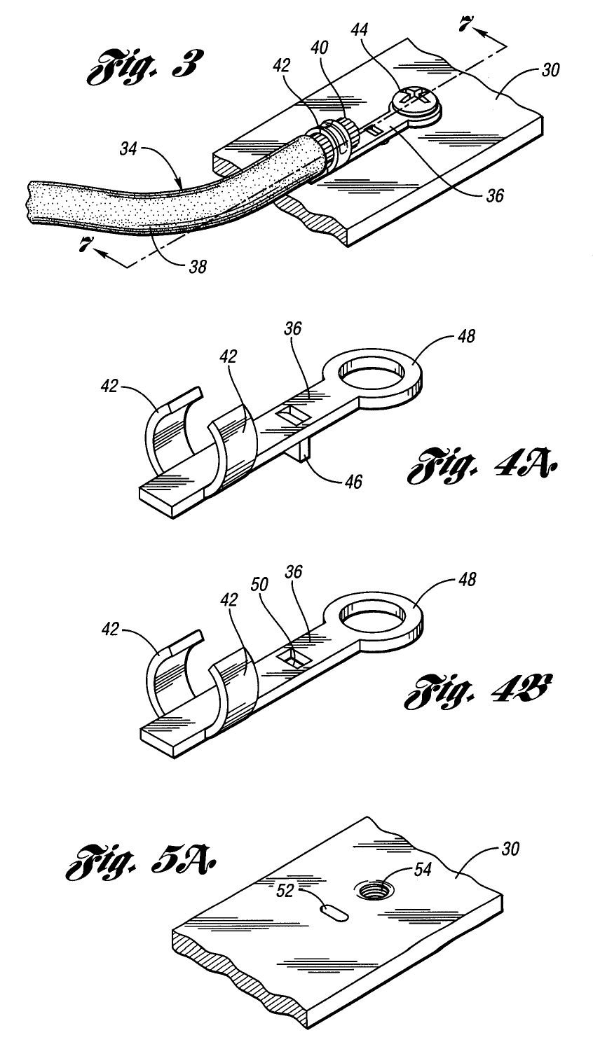

FIG. 4A depicts at least one embodiment of ground terminal 36. As illustrated, ground terminal 36 includes a clasp 42. Clasp 42 extends substantially perpendicular to ground terminal 36 and, in at least one embodiment, is integral therewith. Those of ordinary skill in the art will understand that clasp 42 may alternatively be a separate component that is connected to ground terminal 36. The clasp 42 is configured to receive the wire 40 of electrical component grounding strap 34. Once wire 40 is disposed within clasp 42, clasp 42 may be compressed or crimped about wire 40 to physically secure wire 40 to ground terminal 36 and also to create an electrical connection between ground terminal 36 and wire 40. Ground terminal 36 is preferably made of a material comprising metal such as a hot dipped tin coated copper alloy. In at least one embodiment, the copper alloy comprises 99.9% Cu, 0.02% Te and 0.02% Sn.

In at least one embodiment, ground terminal 36 further includes a ground terminal anti-rotation tab 46 protruding downwardly from ground terminal 36 in a direction opposite to clasp 42. Ground terminal anti-rotation tab 46 may be formed integrally with ground terminal 36. Alternatively, ground terminal anti-rotation tab 46 may be separately manufactured and then attached to ground terminal 36 through a weld or other methods effective to join metal components to one another. Ground terminal anti-rotation tab 46 is configured to fit within an anti-rotation slot defined in the surface to which ground terminal 36 is connected. Ground terminal 36 further includes an eyelet 48 which comprises a substantially circular opening integral with ground terminal 36. Eyelet 48 is configured to receive screw 44 to effect the fastening of ground terminal 36 to the spare tire mounting member 30. In alternative embodiments, however, it is recognized that eyelet 48 may have other shapes without departing from the scope of the present invention.

FIG. 4B depicts an alternative embodiment of ground terminal 36. In the depicted alternative embodiment, instead of having an integral ground terminal anti-rotation tab 46, ground terminal 36 has a ground terminal anti-rotation slot 50 which is configured to receive an anti-rotation tab.

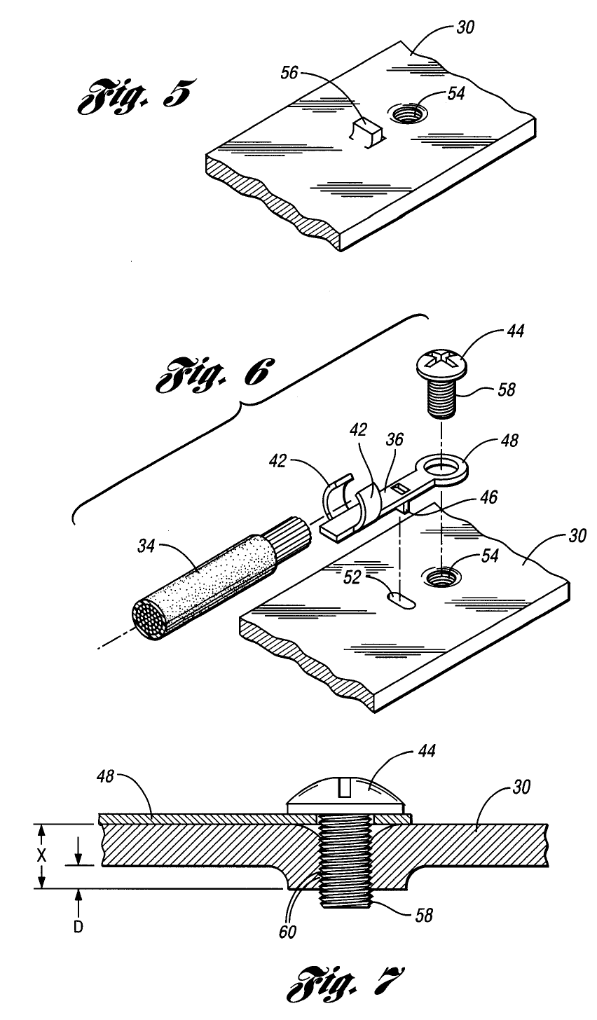

FIG. 5A illustrates an enlarged section of the spare tire mounting member 30 shown in FIG. 3 prior to the attachment of ground terminal 36. As illustrated, spare tire mounting member 30 includes a surface anti-rotation slot 52 and an extruded opening 54. Surface anti-rotation slot 52 is configured to receive ground terminal anti-rotation tab 46 when ground terminal 36 is positioned on spare tire mounting member 30. Extruded hole 54 aligns with eyelet 48 and surface anti-rotation slot 52 aligns with ground terminal anti-rotation tab 46 when ground terminal 36 is properly aligned over spare tire mounting member 30.

FIG. 5B illustrates an alternative embodiment of spare tire mounting member 30 having an extruded opening 54 and a surface anti-rotation tab 56. The alternative embodiment illustrated in FIG. 5B is configured to receive the alternative embodiment of ground terminal 36 illustrated in FIG. 4B. Surface anti-rotation tab 54 may be formed integrally with spare tire mounting member 30. Alternatively, surface anti-rotation tab 56 may be separately made and then attached through welding or other means effective to rigidly secure surface anti-rotation tab 56 to spare tire mounting member 30.

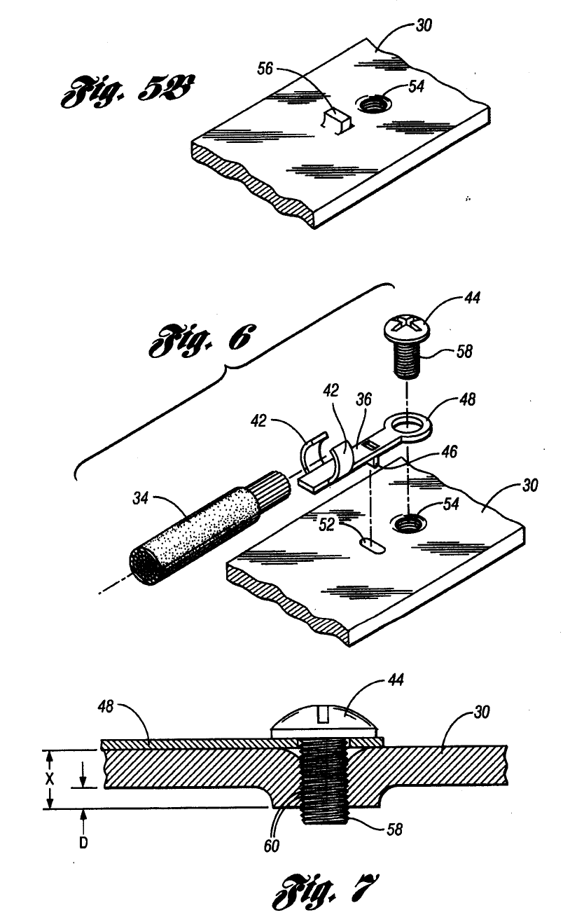

FIG. 6 is an exploded view of the components comprising the grounding system including spare tire mounting member 30, ground terminal 36, electrical component grounding strap 34 and screw 44. Dotted lines are provided to illustrate the way in which the components are connected to one another. Screw 44 is shown having screw threads 58. Extruded opening 54 is also threaded to receive screw threads 58, the two cooperating to provide a threaded engagement to secure ground terminal 36 to spare tire mounting member 30. In at least one embodiment, the screw 44 is a non-hex chrome screw having a non-corrosive finish. Additionally, screw 44 may be a thread-forming screw and can be screwed into an opening that lacks threads. The process of screwing screw 44 into such a threadless hole forms receiving threads in the hole. Accordingly, the configuration illustrated in FIG. 6 would work even if extruded opening 54 lacked threading.

As illustrated in FIG. 6, electrical component grounding strap 34 may be received within clasp 42 and ground terminal 36 is positioned over spare tire mounting member 30 such that ground terminal anti-rotation tab 46 aligns with surface anti-rotation slot 52 and eyelet 48 aligns with extruded opening 54. Once ground terminal 36 is disposed on spare tire mounting member 30, screw 44 is screwed into extruded opening 54. Ground terminal anti-rotation tab 46 cooperates with surface anti-rotation slot 52 to prevent ground terminal 36 from rotating with respect to spare tire mounting member 30 as screw 44 is tightened. This permits a higher torque to be applied to screw 44. Without the cooperation between the anti-rotation slot 52 and the anti-rotation tab 46, the ground terminal 36 may spin as screw 44 is screwed into the spare tire mounting member 30.

FIG. 7 is a cross-sectional fragmentary view taken along the line 7-7 of FIG. 3. In FIG. 7, screw 44 is illustrated as being in threaded engagement with extruded opening 54. The eyelet 48 of ground terminal 36 is disposed between the head portion of screw 44 and a surface of the spare tire mounting member 30. The screw threads 58 are shown in threaded engagement with the extruded opening threads 60 to retain screw 44 in the extruded opening 54. In the embodiment illustrated in FIG. 7, the extruded opening threads 60 in threaded engagement with screw threads 58 have a predetermined depth “X” (e.g. 3 mm) and exceed by a distance D the depth of threaded engagement that would otherwise exist if extruded opening 54 were not extruded. By extruding the opening, a greater depth of threaded engagement results. This, in turn, allows for a greater torque to be applied to screw 44 providing a more robust connection between screw 44 and spare tire mounting member 30. Extruding extruded opening 54 obviates the need to increase the thickness of the sheet metal used to form spare tire mounting member 30 or to increase the length of electrical component grounding strap 34 to reach a grounded structure on the vehicle having a desired thickness.

While the best mode for carrying out the invention has been described in detail, those familiar with the art to which this invention relates will recognize various alternative designs and embodiments for practicing the invention as defined by the following claims.

1. A system for fastening components comprising:
a first member having a surface that defines an extruded opening and a first engagement element;
a second member disposed proximate to the surface, the second member having an eyelet and a second engagement element, the second member being oriented such that the eyelet is axially aligned with the extruded opening and the first and second engagement elements cooperate to inhibit the second member from rotating with respect to the first member; and
a threaded fastener securing the second member to the first member through engagement of the eyelet and the extruded opening.

2. The system of claim 1 wherein the first engagement element is a slot and the second engagement element is a tab and wherein the tab is configured to be disposed within the slot.

3. The system of claim 1 wherein the first engagement element is a tab and the second engagement element is a slot and wherein the slot is configured to be disposed over the tab.

4. The system of claim 1 wherein the threaded fastener is a screw.

5. The system of claim 4 wherein the screw is a thread-forming screw.

6. The system of claim 1 wherein the first and second members are electrically conductive.

7. The system of claim 6 wherein the second member is a wire terminal.

8. The system of claim 6 wherein the first member is an electrically grounded portion of a vehicle.

9. The system of claim 8 wherein the second member is a wire terminal.

10. The system of claim 1 wherein the extruded opening is threaded.

11. A system for securing a grounding wire to a ground plane, the system comprising:
an electrically grounded member having a surface defining an extruded opening and a first engagement element;
an electrical terminal having a wire receiving portion, an eyelet, and a second engagement element, the electrical terminal being disposed proximate to the surface such that the eyelet is axially aligned with the extruded opening and the first and second engagement elements engage each other and cooperate to inhibit the electrical terminal from rotating with respect to the electrically grounded member; and
a threaded fastener fastening the electrical terminal to the electrically grounded member through engagement of the eyelet and the extruded hole.

12. The system of claim 11 wherein the first engagement element is a slot defined in the surface and wherein the second engagement element is a tab configured to be disposed within the slot.

13. The system of claim 11 wherein the first engagement element is a tab defined in the surface and wherein the second engagement element is a slot configured to be disposed over the tab.

14. The system of claim 11 wherein the threaded fastener is a thread-forming screw.

15. The system of claim 11 wherein the extruded hole is threaded.

16. The system of claim 11 where the electrically grounded member is a portion of a vehicle.

17. A system for fastening a grounding wire to a ground plane on a vehicle, the system comprising:
an automotive vehicle having an electrically grounded portion made from a material comprising metal, the electrically grounded portion including a surface, an extruded hole defined in the surface and an anti-rotation slot defined in the surface proximate to the extruded hole;
an electrical terminal connected to the surface proximate to the extruded hole and the anti-rotation slot, the electrical terminal being made from a material comprising metal and having an eyelet, an anti-rotation tab, and a wire receiving portion, the eyelet being disposed proximate to the extruded hole and axially aligned therewith and the anti-rotation tab being received within the anti-rotation slot;
a grounding wire having a first end and a second end, the first end being received within the wire receiving portion of the electrical terminal and secured thereto, and the second end being attachable to an electrical component on the vehicle; and
an electrically conductive screw connecting the eyelet to the extruded hole.

18. The system of claim 17 wherein the extruded hole is threaded and wherein the depth of the threaded portion of the hole is at least approximately 3 millimeters.

19. The system of claim 17 wherein the vehicle has a frame and a body connected to the frame, the frame being electrically grounded to the body.

20. The system of claim 19 wherein the electrically grounded port ion is a spare tire mounting member.
